(19) United States
(12) Patent Application Publication
(10) Pub. No.: US 2008/0011169 A1
(43) Pub. Date: Jan. 17, 2008

(54) Folding device with folding apparatus arranged at different heights

(76) Inventors: Hans Ulrich Siegenthaler, Brenzikofen (CH); Hanspeter Gubler, Bern (CH)

Correspondence Address: RATNERPRESTIA, P O BOX 980, VALLEY FORGE, PA, 19482-0980, US

(21) Appl. No.: 11/714,674

(22) Filed: Mar. 6, 2007

(30) Foreign Application Priority Data
Mar. 6, 2006 (DE) 10 2006 010 602.4

(51) Int. Cl. B41F 5/00

(52) U.S. Cl. 101/212; 270/21.1

(57) ABSTRACT

A folding device in or for a printing machine, said folding device comprising: a) an upper folding apparatus comprising an upper transverse cutting means for transversely cutting a first printed product web into printed products and an upper folding cylinder for transversely folding the printed products; b) and a lower folding apparatus comprising a lower transverse cutting means for transversely cutting a second printed product web into other printed products and a lower folding cylinder for transversely folding the other printed products; c) wherein the upper folding apparatus is arranged above the lower folding apparatus and partly overlaps with the lower folding apparatus.

The invention relates to a folding device with folding apparatus arranged at different heights and to a rotary printing machine which comprises such a folding device. The invention can in particular be realised in roller rotary printing, preferably in offset printing and particularly preferably in newspaper printing.

Flexibly employable printing machines for productions which are either large in their number of pages or partitioned into a plurality of small, parallel productions correspondingly comprise a plurality of folding apparatus. The folding apparatus are dependent on the production requirements and the associated web distances either at a front-facing end or in a central region of the printing machine. For flexibly switching production between large circulations and a partitioned plurality of smaller productions, the construction of so-called double folding apparatus has proven to be of economical value. Double folding apparatus have even been used to partition the copy flow of a production into two copy flows at half the output. This partition used to serve to enable the partly manual or also mechanical discharge of the printed copies to be managed, then as the effectiveness of forwarding systems increased, these so-called split deliveries very quickly gave way to actual synchronous double deliveries, i.e. delivering two different productions at the same speed.

Depending on the spatial conditions, it can be useful to install single or double folding apparatus in the roller basement. One proposal which further increases flexibility is made by EP 0 741 020 B1, in accordance with which a folding apparatus is arranged in the roller basement and another folding apparatus is arranged together with printing units of the printing machine on a system level alongside the printing units. The proposal is also made to install three folding apparatus on the system level alongside the printing units. The proposed installation alternatives do satisfy the desire for flexibility with regard to different productions, but conversely require installation space which is not always available.

It is an object of the invention to provide a folding device which allows flexible switching between different productions and does not take up a lot of space.

The object is solved by means of a folding device which comprises at least two folding apparatus, one of which is arranged above the other and preferably with a lateral offset with respect to it. The folding device therefore comprises a lower folding apparatus and an upper folding apparatus which is arranged above the lower folding apparatus and at least partly, preferably only partly, overlaps with it. Arranging the upper folding apparatus above the lower folding apparatus saves on installation space. If these are offset, as is preferred, the folding device does require more installation space than if they completely overlapped, however offsetting the folding apparatus such that they only partly overlap enables an unrestricted feed into the lower folding apparatus to be provided.

The upper folding apparatus comprises an upper transverse cutting means for transversely cutting a first printed product web into printed products, i.e. printed copies, and an upper folding cylinder for transversely folding the printed products. The lower folding apparatus correspondingly comprises a lower transverse cutting means for transversely cutting a second printed product web into other printed products, and a lower folding cylinder for transversely folding the other printed products. The folding apparatus should exhibit an offset with respect to each other in a direction transverse to the rotational axis of one of the folding cylinders, preferably only in this direction, and should be arranged at least substantially one above the other in vertical alignment in the axial direction of the relevant folding cylinder. The two folding apparatus are preferably offset far enough with respect to each other that the second printed product web can be conveyed past the upper folding apparatus over a short distance into the lower transverse cutting means. This is possible in particular when the second printed product web, if vertically conveyed, can be conveyed in parallel alongside the first printed product web and, once it has been fed into the upper transverse cutting means, can be conveyed into the lower transverse cutting means, parallel to the alignment of the first printed product web. This does not mean that the second printed product web must always be conveyed exactly vertically alongside and past the upper folding apparatus or that the first printed product web must at all events be conveyed vertically into the upper transverse cutting means, although conveying in this way is preferred, in order to convey the printed product webs which are ready for transversely folding into the respective folding apparatus over the shortest web distance possible. Thus, it is perfectly possible, though less preferred, for the second printed product web having a smaller offset or no offset to be diverted towards the lower transverse cutting means again before being fed into it, in order to guide it past the upper folding apparatus. The offset should be as small as possible, so that the folding device takes up as little installation space as possible. An offset which just about still enables the web to be guided in the manner described as preferred is therefore particularly preferred.

The folding device can be arranged in a printing machine comprising a plurality of adjacently arranged printing towers at one end of the row of printing towers. More preferably, however, it is arranged in a central region of the printing machine between two printing towers, such that printed product webs can be conveyed to the folding device from two sides. Although the folding apparatus can in principle be installed such that the rotational axis of the upper folding cylinder is inclined with respect to the rotational axis of the lower folding cylinder, it is preferable for the folding apparatus to exhibit the same orientation, i.e. for the rotational axes of their folding cylinders to be parallel to each other. The folding apparatus are preferably orientated such that they deliver the transversely folded printed products to the same side.

In preferred embodiments, the upper folding apparatus is arranged not only above the lower folding apparatus but on top of it, i.e. it is directly supported on a frame, preferably the side walls of the lower folding apparatus. Using this measure, a bearing table or other supporting means for the upper folding apparatus is avoided. The height of the folding device is also reduced to a minimum.

The lower folding apparatus can be arranged, together with reel changers, on a floor of a roller basement. The upper folding apparatus can stand, together with the printing units, above the roller basement on a ceiling forming the system level, such that the ceiling forms the aforementioned supporting means. As mentioned, however, the upper folding apparatus more preferably rests on the lower folding apparatus. Arranging the lower folding apparatus in the roller basement does enable the upper folding apparatus to be arranged at an advantageously low level, however a folding apparatus standing at the level of the reel changers in the roller basement restricts the logistics in the roller basement, at least if the folding device is arranged in the central region of the printing machine. The lower folding apparatus therefore preferably stands above the floor of the roller basement, either on an intermediate ceiling or on the system level on which the printing units are also supported. Although less preferred, the reel changers can also be installed on the system level. The intermediate ceiling on which the lower folding apparatus is installed, raised off the basement floor, exhibits a clear distance from the basement floor which is preferably large enough to enable a web reel to be transported through between the basement floor and the intermediate ceiling. The intermediate ceiling can be dropped from a ceiling forming the system level or can be formed by a bearing table. A combination of a dropped ceiling and supporting the intermediate ceiling on supporting elements, for example pillars, is preferred.

In preferred embodiments, the folding device also comprises a longitudinal folding means for longitudinally folding the printed product webs. The longitudinal folding means preferably comprises a plurality of formers arranged adjacently at the same height. It can also comprise a balloon former arrangement, i.e. formers arranged at different heights. In one preferred variant, it comprises or consists of three formers which are arranged adjacently at the same height, and three other formers which are arranged, also adjacently, at a different height, preferably above the first three formers. In order to save on height, a different preferred variant provides for arranging formers only adjacently at the same height, wherein the number of formers is preferably larger than the number of double pages which can be printed in the printing units. If, for example, the folding device is provided for a printing machine which prints to a width of four pages, or is installed in such a machine, then at least three, particularly preferably exactly three, formers are preferably arranged adjacently at the same height. If, for example, the machine prints to a width of six pages, then at least four, particularly preferably exactly four, formers are preferably arranged adjacently at the same height.

The invention relates not only to a folding device as such which can for example only be provided for installation in a printing machine, but also to a printing machine comprising a folding device in accordance with the invention. The printing machine is preferably a rotary printing machine, particular preferably a roller rotary printing machine. The rotary printing machine comprises the printing units already mentioned several times and comprising printing cylinders which form printing gaps for a plurality of webs. The printing units can in particular be satellite printing units, for example nine-cylinder or ten-cylinder units, or so-called rubber/rubber printing units. Preferred printing units and drives for such printing units are described in EP 0 644 048 A1 which is referenced in this respect. The folding device is preferably driven by a drive of its own. Particularly preferably, each of the folding apparatus is respectively equipped with a drive of its own. Preferred drives for folding apparatus are described in EP 0 741 019 A1 which is referenced in this respect.

Other preferred features are also described in the sub-claims and combinations of them. The features described therein and the embodiments described above reciprocally complement each other.

Example embodiments of the invention are explained below on the basis of figures. Features disclosed by the example embodiments, each individually and in any combination of features, advantageously develop the subjects of the claims and the embodiments described above. There is shown:

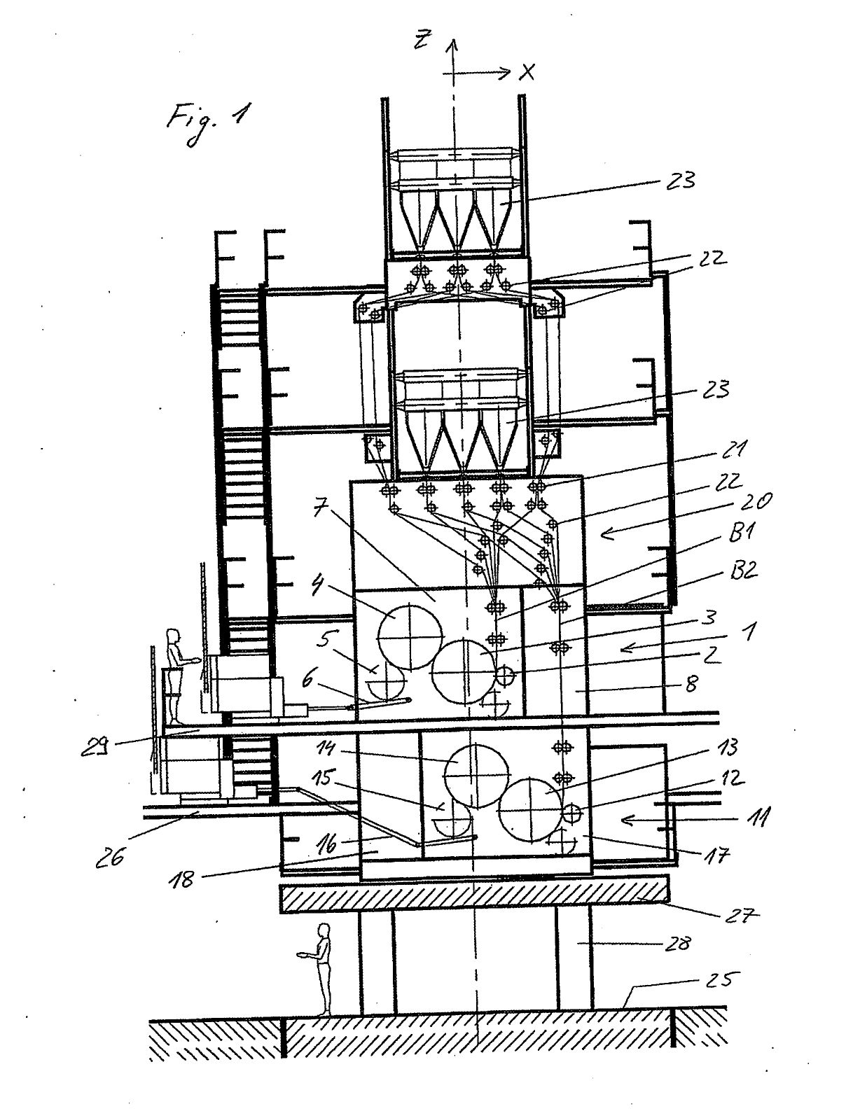

FIG. 1 a first example embodiment of a folding device, in a first view;

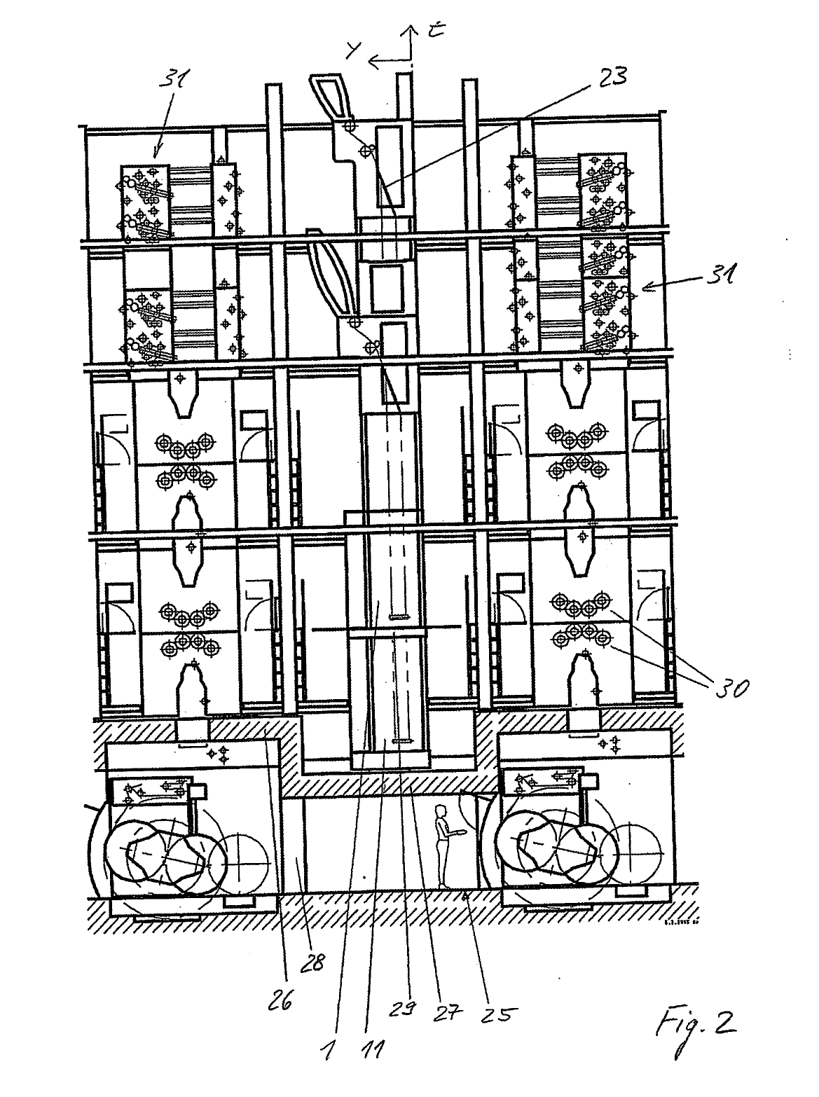

FIG. 2 the folding device of FIG. 1 in a different view, together with two printing towers of a roller rotary printing machine;

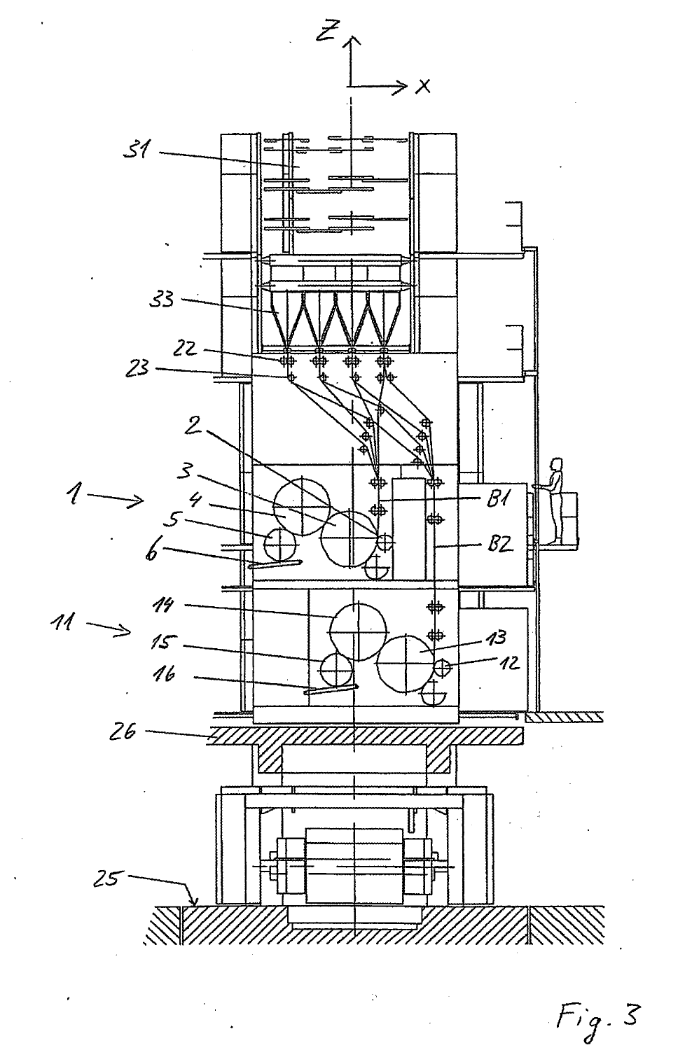

FIG. 3 a second example embodiment of a folding device; and

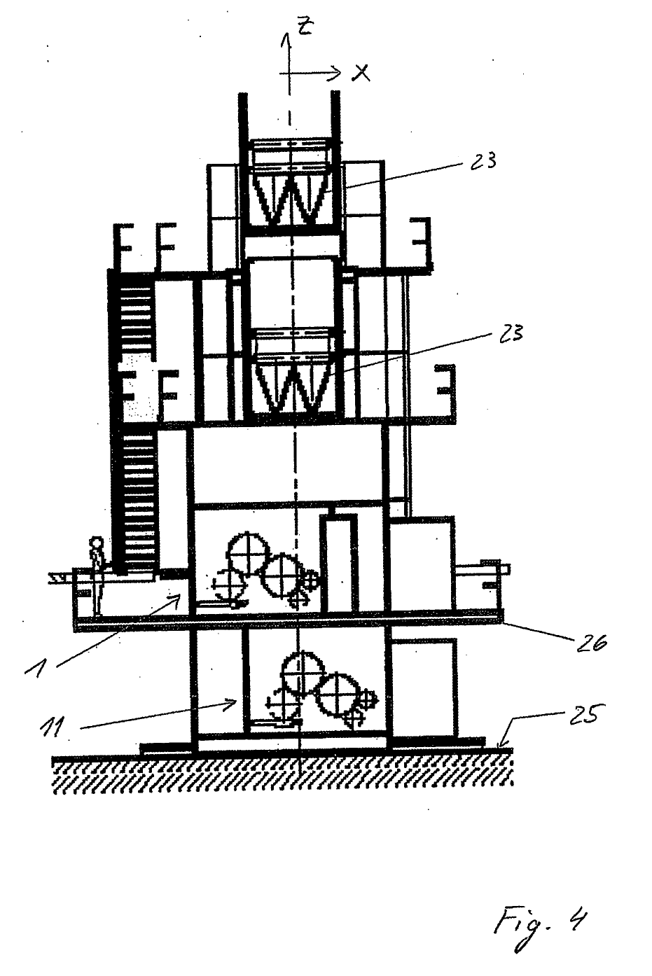

FIG. 4 a third example embodiment of a folding device.

FIGS. 1 and 2 show a roller rotary printing machine comprising a folding device in a first example embodiment. FIG. 1 shows a view onto the folding device in the longitudinal direction of the printing machine. FIG. 2 shows a central region of the printing machine in a lateral view. The printing machine comprises a plurality of printing towers, each comprising a plurality of printing units 30, each consisting of a transfer cylinder, a plate cylinder and assigned inking units, and preferably also assigned dampening units for offset printing, preferably wet offset printing. The printing units 30 form four printing gaps per printing tower, for duplex full-colour printing. Within the printing towers, the printing units 30 are arranged into so-called H-printing units. Instead of the octal towers shown, the printing towers could also be embodied as decadal or dodecadal towers, i.e. can comprise five or six printing gaps one above the other. Using printing towers extended in this way, it is possible to switch from one production to another—while the web is running—particular flexibly, by conveying the web during the first production through more printing gaps than are actually used for production. When switching production, the transfer cylinders of the printing gap or gaps not previously used can be advanced, and the transfer cylinders of a printing gap or plurality of printing gaps previously used for printing can be retracted from each other. Such a flexibility with respect to switching from one production to another while the web continues to run can also be similarly obtained using satellite printing units. To the left and right of the two central printing towers shown in FIG. 2, at least one other printing tower is arranged in each case in the longitudinal direction Y of the printing machine, and can in particular—like the two printing towers shown—be formed as an octal tower, or alternatively can also be formed as a decadal or dodecadal tower. The adjacent printing towers can also comprise or consist of printing units in a satellite construction. As opposed to the other printing towers, however, the two central printing towers each have a means 31 for merging printed webs arranged above them. The means 31 are turning bar means.

Arranged between the two central printing towers is a folding device comprising two folding apparatus 1 and 11 for transversely folding printed products. The folding apparatus 1 and 11 are arranged vertically one above the other, wherein the lower folding apparatus 11, i.e. a frame of the lower folding apparatus 11, supports the upper folding apparatus 1. The folding apparatus 1 and 11 are thus stacked one on top of the other. Two longitudinal folding means 23 are arranged vertically above the folding device 1, 11 and, as shown in FIG. 1, are embodied as a so-called balloon former arrangement, each comprising three formers arranged adjacently at the same height.

The folding device 1, 11, the folding structure and the folding superstructure including the longitudinal folding means 23 is installed on an intermediate ceiling 27. The intermediate ceiling 27 is an installation level inserted vertically between a floor 25 of a roller basement forming a level for the reel changers and a ceiling 26. The ceiling 27 forms the system level on which the printing towers stand. A plurality of reel changers stand on the floor 25 of the roller basement, preferably one reel changer per printing tower. The intermediate ceiling 27 is dropped from the ceiling 26 forming the system level and is additionally supported by supporting elements 28—in the example embodiment, supporting pillars. The vertical clear distance between the floor 25 of the roller basement and the intermediate ceiling 27 is slightly more than the height of a man. The supporting elements 28 are spaced far enough from each other to enable web reels to be transported through between the supporting elements 28, preferably both in the X direction parallel to the rotational axes of the printing cylinders and in the longitudinal direction Y of the printing machine.

As shown in FIG. 1, the folding apparatus 1 and 11 are arranged offset with respect to each other in the X direction. However, FIG. 2 shows that there is no offset in relation to the Y direction, but rather that the folding apparatus 1 and 11, in particular their cylinders, are in exact vertical alignment in relation to the Y direction.

The upper folding apparatus 1 comprises a transverse cutting means consisting of a cutting cylinder 2 and a collecting cylinder 3, as well as a folding cylinder 4, a paddle wheel 5 and a delivery device 6 in the form of a belt delivery device. The corresponding components of the lower folding apparatus 11 are provided with reference signs raised by the number 10. The only difference is with regard to the delivery device 16, which is extended as compared to the upper delivery device 6 in accordance with the offset.

The folding cylinders 4 and 14 can in particular be folding flap cylinders. Alternatively, however, they can also be formed as rotating folding cylinders, and the folding apparatus 1 and 11 correspondingly formed as rotating folding apparatus. The combination of a flap folding apparatus and a rotating folding apparatus is also advantageous.

The rotational axes of the cylinders of the folding apparatus 1 and 11 point at right angles to the rotational axes of the printing cylinders. Correspondingly, the transversely cut printed products are conveyed through the folding apparatus 1 and 11 at right angles to the web plane in the printing towers. The folding apparatus 1 and 11 deliver to the same side.

The transverse cutting means 2, 3 and 12, 13 each form a gap which the respectively assigned printed product web B1 or B2 is fed into. The upper folding apparatus 1 is offset to the side of the delivery devices 6 and 16 with respect to the lower folding apparatus 11, far enough that the printed product web B2 can be vertically conveyed linearly downwards, alongside the upper folding apparatus 1, into the gap of the lower transverse cutting means 12, 13. The offset of the folding apparatus 1 and 11 is correspondingly measured between the feed gap of the upper transverse cutting means 2, 3 and the feed gap of the lower transverse cutting means 12, 13. The offset should however be as small as possible, in order to keep the required installation space in the X direction, i.e. parallel to the rotational axes of the printing cylinders, as short as possible. The offset should therefore be small enough that the feed gap of the upper transverse cutting means 2, 3 at least still overlaps with the lower folding cylinder 14 or as applicable even with the collecting cylinder 13. An optimum offset is one at which the upper collecting cylinder 3 still largely, preferably predominantly, overlaps vertically with the lower folding cylinder 14, as shown by way of example in FIG. 1. In relation to a central vertical axis Z of the printing machine, central with respect to the width of the printing machine as measured in the X direction, it is advantageous if the two folding apparatus 1 and 11 are each offset by about the same length, in the −X direction on the one hand and in the +X direction on the other, with respect to an arrangement which is exactly centred in each case. Each of the folding apparatus 1 and 11 is thus offset by at least substantially the same length with respect to an arrangement which is exactly centred. Particularly favourable conditions result if the rotational axis of the upper collecting cylinder 3 comes to rest slightly to the side of the upper delivery device 6 alongside the central vertical axis Z, and the rotational axis of the lower folding cylinder 14 comes to rest slightly to the other side alongside the central vertical axis Z. If they have the same diameter, these two cylinders 3 and 4 will thus not completely but only largely overlap.

The folding device 1, 11 also comprises an operating deck 29 which is embodied as an intermediate deck and rests on the lower folding apparatus 11. The upper folding apparatus 1 stands on the operating deck 29. The operating deck 29 is cantilevered, i.e. it is not otherwise architecturally supported. Alternatively, however, it would also be possible for the operating deck 29 to not be supported by the printing machine, in particular not by the folding apparatus 11, but rather by some other construction.

The moving components of the folding apparatus 1 and 11 are mounted by stable side walls 7 and 17. The side wall 17 of the lower folding apparatus 11 extended by a supporting wall 18 in order to support the upper folding apparatus 1 towards the side of the delivery device 16. The side wall 7 of the upper folding apparatus 1 is extended by an intermediate wall 8 towards the other side, in the region of the printed product web B2 passing through, although said wall 8 does not have a comparable supporting function but primarily only assumes the function of mounting guiding rollers, for example drawing rollers, for the printed product web B2.

FIG. 3 shows a folding device of a second example embodiment, in a view in the longitudinal direction Y of the printing machine. The folding device 1, 11 of the second example embodiment corresponds to that of the first example embodiment with regard to the folding apparatus 1 and 11. In particular, the statements regarding the lateral offset made with respect to the first example embodiment apply. Correspondingly, the folding apparatus 1 and 11 and also their components are provided with the same reference signs. The only differences are with regard to the installation of the folding device 1, 11 as a whole and the longitudinal folding means which in the second example embodiment is provided with the reference sign 33 in order to distinguish it.

The folding device 1, 11 of the second example embodiment does not rest on an intermediate ceiling, but rather together with the printing units 30 on the ceiling 26 forming the system level. Correspondingly, the folding apparatus 1 and 11 of the second example embodiment assume higher vertical positions relative to the printing units 30 than the folding apparatus 1 and 11 of the first example embodiment. In order to compensate for the higher vertical position, the longitudinal folding means 33 only comprises folders arranged adjacently at the same height. In the example embodiment, the longitudinal folding means 33 consists of four adjacently arranged folders. A second folder level does not exist. The machine is preferably one which prints to a width of six pages. In principle, only three of the folders are required in order to be able to longitudinally fold the resultant three double pages as brochures. However, the fourth folder allows a fourth brochure to be formed, which is in particular advantageous in productions comprising a large number of pages per printed product. In such productions, it is possible to reduce the volume of the individual brochures or the volume of the thickest of the brochures by forming a fourth brochure. The relevant longitudinally cut web strands merely have to be correspondingly turned onto the fourth folder. The four longitudinally folded brochures or also only a portion of the four longitudinally folded brochures can be divided up beyond the folders, as shown by way of example in FIG. 3, and fed to the downstream folding apparatus 1 and 11 as the printed product webs B1 and B2. Depending on the print occupancy, two identical or non-identical printed product webs B1 and B2 and correspondingly identical or non-identical printed products can be produced in this way.

FIG. 4 shows a third installation variant of the two folding apparatus 1 and 11. In this third example embodiment, the lower folding apparatus 11 stands on the floor 25 of the roller basement forming the level for the reel changers, and the upper folding apparatus 1 stands on the ceiling 26 forming the system level. FIG. 4 shows an example of a printing machine which prints to a width of four pages, comprising two longitudinal folding means 23 arranged vertically one above the other, each consisting of two folders arranged adjacently at the same height. Aside from these differences, the statements made with respect to the two other example embodiments apply to the third example embodiment.

1. A folding device in or for a printing machine, said folding device comprising:
a) an upper folding apparatus comprising an upper transverse cutting means for transversely cutting a first printed product web into printed products and an upper folding cylinder for transversely folding the printed products;
b) and a lower folding apparatus comprising a lower transverse cutting means for transversely cutting a second printed product web into other printed products and a lower folding cylinder for transversely folding the other printed products;
c) wherein the upper folding apparatus is arranged above the lower folding apparatus and partly overlaps with the lower folding apparatus (11).

2. The folding device according to claim 1, wherein the upper and lower transverse cutting means are laterally offset far enough with respect to each other such that the second printed product web is convevable in a vertical orientation parallel alongside the first printed product web and into the lower transverse cutting means.

3. The folding device according to claim 1, wherein the upper folding apparatus is arranged on top of the lower folding apparatus.

4. The folding device according to claim 1, wherein the lower folding apparatus is arranged together with printing units of the printing machine on a system level.

5. The folding device according to claim 1, wherein the lower folding apparatus is arranged on an intermediate ceiling arranged vertically between a floor of a roller basement and a ceiling on which printing units of the printing machine are supported.

6. The folding device according to claim 1, wherein the lower folding apparatus is arranged together with reel changers in a roller basement of the printing machine on a common level for the reel changers or on a plinth which is raised as compared to the level for the reel changers.

7. The folding device according to claim 1, wherein at least a portion of the upper transverse cutting means are arranged above the lower folding cylinder.

8. The folding device according to claim 1, wherein the folding cylinders are arranged within the axial length of printing units of the printing machine, wherein the axial length is measured in the axial direction of printing cylinders of the printing units.

9. The folding device according to claim 1, wherein the transverse cutting means of at least one of the folding apparatus and the folding cylinder of the other folding apparatus are arranged within the axial length of printing units of the printing machine, wherein the axial length is measured in the axial direction of printing cylinders of the printing units.

10. The folding device according to claim 1, wherein the folding apparatus each comprise a delivery device on the same side.

11. The folding device according to claim 1, wherein an accessible operating deck for the upper folding apparatus is arranged on top of the lower folding apparatus.

12. The folding device according to claim 1, wherein the upper transverse cutting means and the lower transverse cutting means each comprise a cutting cylinder and a collecting cylinder which together form a gap for the respective printed product web and wherein the collecting cylinder of one of the folding apparatus and the folding cylinder of the other folding apparatus are arranged in a central region of the printing cylinders, as viewed in the axial direction of printing cylinders of the printing machine.

13. The folding device according to claim 1, further comprising an upper longitudinal folding means and a lower longitudinal folding means, wherein the upper transverse cutting means and the lower transverse cutting means each comprise a cutting cylinder and a collecting cylinder which together form a gap for the respective printed product web, wherein the gap of the upper transverse cutting means is arranged below the lower longitudinal folding means and the gap of the lower transverse cutting means is arranged laterally alongside the lower longitudinal folding means.

14. The folding device according to claim 13, wherein at least one of the longitudinal folding means comprises at least three folders arranged, above the folding device at least substantially at the same height.

15. The folding device according to claim 1, further comprising a longitudinal folding means comprising at least four folders arranged above the folding device at least substantially at the same height.

16. The folding device according to claim 15, wherein the longitudinal folding means comprises a number of adjacent folders corresponding to the number of newspaper pages which can be printed adjacently onto a maximum-width web.

17. The folding device according to claim 1, wherein for driving the upper and lower folding apparatuses, each is provided with a drive motor of its own.

18. The folding device according to claim 1, wherein the upper and lower folding apparatuses are identical.

19. The folding device according to claim 1, wherein the upper and lower folding apparatuses are flap folding apparatus.

20. The folding device according to claim 1, wherein one of the folding apparatus is a flap folding apparatus and the other folding apparatus is a rotating folding apparatus.

21. A rotary printing machine comprising:
a) printing units comprising printing cylinders which each form at least one printing gap for printing one or both sides of a web;
b) a means for merging printing webs into printed product webs;
c) and a folding device according to claim 1 for transversely cutting the printed product webs into printed products and for transversely folding the printed products.

22. The rotary printing machine according to claim 21, further comprising a plurality of adjacently arranged printing towers, in each of which a plurality of the printing units are arranged one above the other, wherein the folding device is arranged in a central region of the rotary printing machine between two printing towers and wherein the printed webs can be conveyed into the folding device from both sides.

23. The rotary printing machine according to claims 21, wherein the rotational axes of the folding cylinders point transverse to the rotational axes of the printing cylinders.

24. The folding device according to claim 14, wherein the at least three folders arranged adjacently.

25. The folding device according to claim 1, wherein the transverse cutting means, the folding cylinders, or both, of the upper and lower folding apparatuses, are identical.

26. The rotary printing machine according to claim 21, wherein the printing machine is a roller rotary printing machine.
